(19) United States
(12) Patent Application Publication
(10) Pub. No.: US 2014/0226030 A1
(43) Pub. Date: Aug. 14, 2014

(54) WIRELESS COMMUNICATION DEVICE

(71) Applicant: CANON KABUSHIKI KAISHA, Tokyo (JP)

(72) Inventor: Takashi Aizawa, Yokohama-shi (JP)

(73) Assignee: CANON KABUSHIKI KAISHA, Tokyo (JP)

(21) Appl. No.: 14/253,802

(22) Filed: Apr. 15, 2014

Related U.S. Application Data
(63) Continuation of application No. 11/519,961, filed on Sep. 13, 2006.

(30) Foreign Application Priority Data
Sep. 14, 2005 (JP) 2005-267692

(51) Int. Cl. H04B 7/26; H04N 5/222

(52) U.S. Cl. CPC H04B 7/26; H04N 5/222
USPC 348/207.1

(57) ABSTRACT

A wireless communication device is connected to an external device such as a personal computer. If an image capture device such as a digital camera is wirelessly connected to the external device, the wireless communication device behaves as the image capture device. If the image capture device is wirelessly connected to the external device, the wireless communication device relays information between the external device and the image capture device.

### BACKGROUND OF THE INVENTION

1. Field of the Invention

The present invention relates to a wireless communication device or the like that wirelessly connects an image capture device such as a digital camera and an external device such as a personal computer.

2. Description of the Related Art

In an image capture device such as a digital camera, a recording device is integrated with the image capture device and image data is recorded to a recording medium built in or inserted in the recording device. As disclosed in Japanese Patent Laid-Open No. 2005-223710, digital interfaces provided in both a digital camera and an external device are connected by a cable to transfer data from the digital camera to the external device such as a personal computer (hereinafter, “PC”). This makes image data recorded and reside in the digital camera accessible by external devices such as the PC.

In recent years, a digital camera and a printer capable of performing a direct printing have also been commercialized. In the direct printing, the digital camera and the printer are directly connected by a cable and printing operations are executed without using a PC.

When data transfer directly between the digital camera and the external device is performed, conventionally, wired connection for connecting USB (universal serial bus) interfaces using a cable has been generally adopted. Data exchange is performed in accordance with a predetermined communication protocol on such a physical channel.

As a data exchange protocol for the PC and the digital camera, for example, the PTP (Picture Transfer Protocol) defined in the Still Imaging Device Class of the USB or a protocol defined in the mass-storage device class is often used.

In particular, in a PC on which the Windows® XP or the Mac OS® X supporting the PTP as a function of the OS is installed, when a digital camera is connected, what is connected can be identified as a digital camera. Accordingly, for example, operations such as automatically launching a data transfer application and starting data transfer are possible. As a result, reduction in burdens on users and improvement of convenience are realized.

Concerning the direct print, a standard called PictBridge that defines a procedure in directly connecting a digital camera and a printer has also been proposed. According to Version 1.0 of this standard, when the mutual connection is completed, a user is capable of selecting an image to be printed and instructing to print using an operation unit and a display unit on the digital camera. Since the PTP is also used for communication between devices in the PictBridge standard, regardless of whether an external device to which the digital camera is connected is a PC or a printer, the user may operate the external device in the same manner if the digital camera supports the PTP communication.

Moreover, recently, according to the progress in the wireless network technology and the reduction in prices, a wireless communication function conforming to the wireless communication standards such as Bluetooth® and IEEE 802.11b have been actively built in various devices.

However, in order to realize the wireless communication function, the respective devices require modules for wireless communication, antennas, and the like. In the present situation, a problem such as component cost, securing of mounting spaces, or loads of addition of functions to system software has not been solved. In particular, in low-price devices, the wireless communication function is not offered as a standard function.

On the other hand, a product called a wireless communication adapter for adding the wireless communication function to a PC not having the wireless communication function has been put on the market. Wireless communication adapters are connected to extension slots (a PCI slot, PC card slot, etc.) provided in the PC and external interfaces (USB, IEEE 1394, etc.) to realize the wireless communication function through the interfaces.

In general, such a wireless communication adapter requires dedicated driver software. This driver software causes the PC to identify the wireless communication adapters connected to the various interfaces as wireless network devices.

However, at present, devices connected through a wireless network are typically PCs, printers, and the like. This is not a situation well-prepared for connection of portable devices such as a digital camera. An OS these days has, as a standard, device drivers for connecting a digital camera to the PC with a USB interface and using the digital camera via the USB interface. Therefore, a user can make the PC identify and use the digital camera if the user connects the digital camera and the USB interface of the PC.

However, a digital camera applicable to wireless communication is not widely used presently. Therefore, in general, by installing dedicated device driver software in the PC or using a general-purpose network protocol such as the FTP, the PC can identify and use the digital camera having wireless communicating function.

When the dedicated device drive software is used, installation by the user is required anew. In addition, development loads of the device driver software increase. In case where the protocol such as the FTP generally adopted in the network is used, the user is required to prepare an FTP server. Since the PC cannot identify a device connected via the FTP, the user is required to have knowledge and skills concerning the network in a communication setting or the like. Therefore, the user is required to have ability higher than that required at the time of USB connection. It is necessary to implement software for performing communication by a protocol completely different from that used for USB connection, in the digital camera. This also increases development loads.

A standard concerning direct print such as the PictBridge also assumes that a wire connection by the USB is used. Therefore, when the digital camera uses the general-purpose protocol such as the FTP on the wireless connection, it is necessary to make it possible to use an equivalent protocol on the printer as well.

As described above, conventionally, for the connection of the digital camera and the external device, the OS and the standard are established on the condition that the USB interface is connected by wire. Therefore, it is difficult for the user to easily perform the connection of the digital camera and the external device by wireless communication.

### SUMMARY OF THE INVENTION

The present invention is directed to overcome the above-described drawbacks and disadvantages. The present invention, for example, is directed to allow a user to easily perform connection of a digital camera and an external device by wireless communication.

According to an aspect of the present invention, there is provided a wireless communication device having both a wireless communication unit and a wired communication unit and is used for realizing communication between a first external device connected to the wired communication unit and a second external device wirelessly connected by the wireless communication unit, the wireless communication device comprising: a responder unit adapted to behave as the second external device for communication from the first external device to the second external device, during a state in which the first external device is connected to the wired communication unit and wireless connection with the second external device is not established; and a control unit adapted to cause the wireless communication unit to transmit data from the first external device to the second external device and cause the wired communication unit to transmit data from the second external device to the first external device, during a state in which the first external device is connected to the wired communication unit and wireless connection with the second external device is established.

Further features and aspects of the present invention will become apparent from the following description of exemplary embodiments with reference to the attached drawings.

### BRIEF DESCRIPTION OF THE DRAWINGS

FIG. 1 is a diagram showing an exemplary structure of a wireless communication system according to first and second exemplary embodiments of the present invention;

FIG. 2 is a block diagram showing an exemplary structure of a digital camera 100 according to the first and the second exemplary embodiments;

FIG. 3 is a block diagram showing an exemplary structure of a wireless communication adapter 300 according to the first and the second exemplary embodiments;

FIG. 4 is a diagram for explaining software modules implemented in the digital camera 100 according to the first and the second exemplary embodiments, a relation among the software modules, and operations of the software modules;

FIG. 5 is a diagram for explaining software modules implemented in the wireless communication adapter 300 according to the first and the second exemplary embodiments, a relation among the software modules, and operations of the software modules;

FIG. 6 is a sequence chart showing operations of the wireless communication adapter 300 according to the first exemplary embodiment together with operations of a digital camera and a PC;

FIG. 7 is a sequence chart showing operations of the wireless communication adapter 300 according to the second exemplary embodiment together with operations of a digital camera and a PC; and

FIG. 8 is a block diagram showing an exemplary structure of a PC 200 according to the first and the second exemplary embodiment.

### DESCRIPTION OF THE EMBODIMENTS

Exemplary embodiments, features and aspects of the present invention will now be described in detail below with reference to the attached drawings.

<First Exemplary Embodiment>

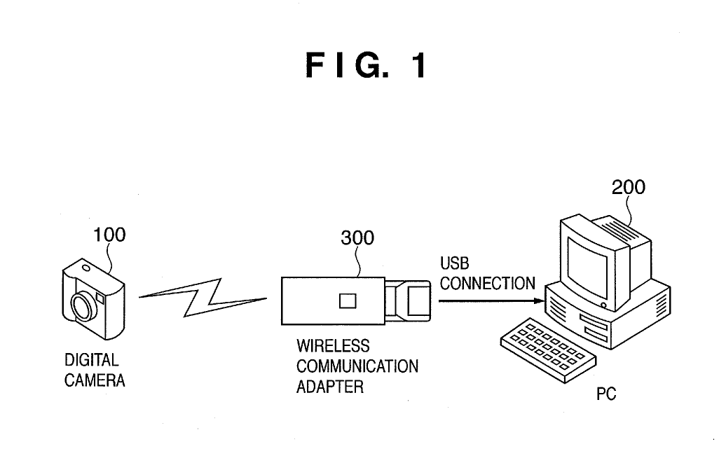

FIG. 1 is a diagram showing an exemplary structure of a wireless communication system according to a first exemplary embodiment of the present invention. The wireless communication system according to this embodiment includes a wireless communication adapter 300 serving as a wireless communication device, a digital camera 100 that is an example of an image capture device, and a personal computer (PC) 200 that is an example of an external device.

In FIG. 1, a wireless communication function can be built in or attached to the digital camera 100. The digital camera 100 is capable of performing wireless communication with the wireless communication adapter 300 serving as a wireless communication device. The wireless communication adapter 300 can be connected to the PC 200 by the USB (Universal Serial Bus). As described later, viewed from the PC 200, the wireless communication adapter 300 virtually behaves as a digital camera connected to the PC 200 by wire.

(Structure of the PC 200)

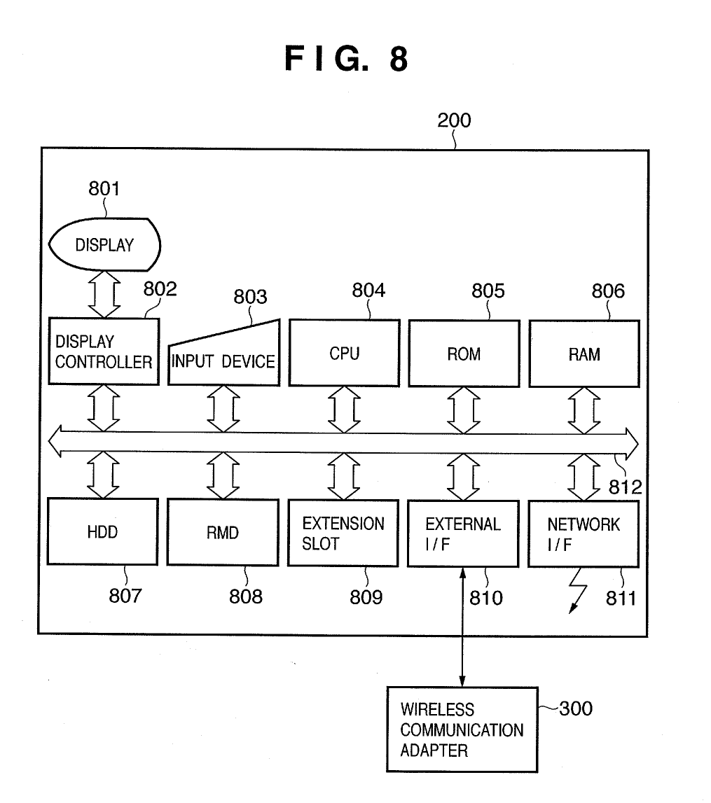

FIG. 8 is a block diagram showing an exemplary structure of the PC 200 according to this embodiment.

In FIG. 8, a display 801 displays information on data being processed by an application program, various message menus, and the like. The display 801 is constituted by a CRT (Cathode Ray Tube) or an LCD (Liquid Crystal Display). A display controller 802 performs control of screen display on the display 801. An input device 803 is used for inputting characters and the like and pointing an icon, a button, and the like in a GUI (Graphical User Interface). Specifically, examples of the input device 803 include a keyboard, a mouse, a track ball, a joy stick, and a touch panel. A CPU (Central Processing Unit) 804 manages control of the entire PC 200.

A ROM (Read Only Memory) 805 has stored therein programs, parameters, and the like executed by the CPU 804. A RAM (Random Access Memory) 806 is used as a work area at the time when the CPU 804 executes various programs, a temporary save area at the time of error processing, and the like.

A hard disk drive (HDD) 807 and a removable media drive (RMD) 808 function as storage devices for the PC 200. The RMD 808 is a device that reads data from and writes data in or reads out data from a removable recording medium. The RMD 808 may be not only a flexible disk drive, an optical disk drive, a magneto-optical disk drive, or a memory card reader but also a removable HDD or the like.

Programs that realize various functions of the PC 200 according to this embodiment are stored in one or more of the ROM 805, the HDD 807, and the RMD 808. An OS, application programs such as a browser, data, libraries, and the like are also stored in one or more the recording media such as the ROM 805, the HDD 807, and the RMD 808 according uses thereof.

An extension slot 809 is, for example, a slot for inserting an extension card conforming to the PCI (Peripheral Component Interconnect) bus standard. It is possible to insert various extension boards such as a video capture board, a sound board, and a GPIB board in the extension slot 809.

An external interface 810 is a communication interface conforming to the USB (Universal Serial Bus) standard such as USB 2.0. The external interface 810 is connected to the wireless communication adapter 300 by the USB.

A network interface 811 has a wired communication function conforming to the IEEE 802.3x standard (x is i, u, z, or ab) or the like. A bus 812 includes an address bus, a data bus, and a control bus and connects the respective units to one another.

(Structure of the Digital Camera 100)

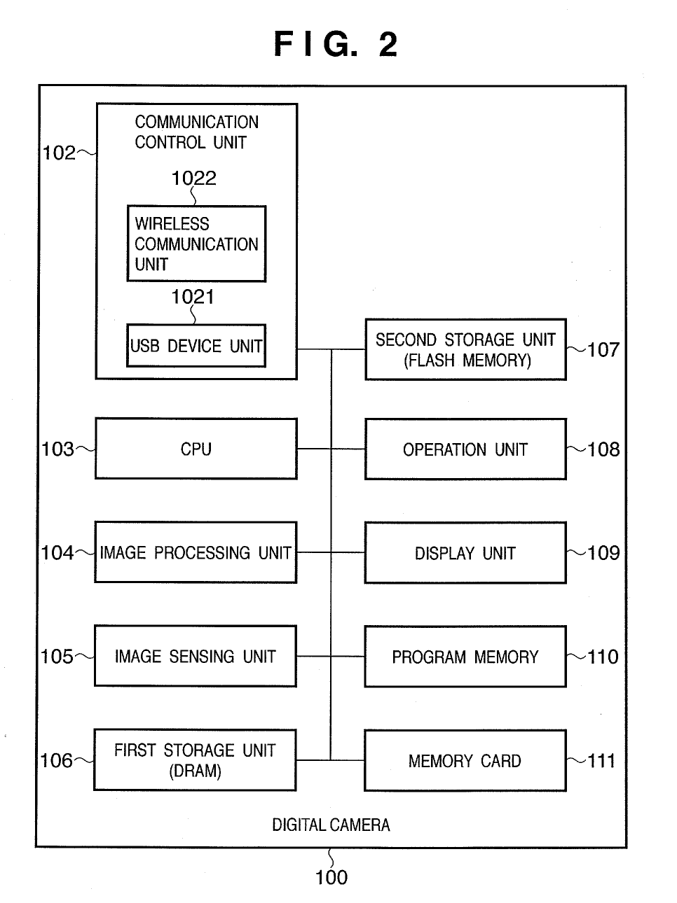

FIG. 2 is a block diagram showing an exemplary structure of the digital camera 100 according to this embodiment.

In FIG. 2, an image capture unit 105 includes a lens unit, an image sensing element, and a driving circuit. It is possible to use a CCD image sensor or a CMOS image sensor as the image sensing element. An image processing unit 104 processes image data and the like of an image (a still image or a moving image) photographed. A CPU (Central Processing Unit) 103 controls operations of the digital camera 100 using a control program and the like stored in a program memory 110.

A first storage unit 106 is constituted by a DRAM or the like and holds image data of an image photographed. A second storage unit 107 is constituted by a flash memory or the like and stores various settings concerning the digital camera 100. An operation unit 108 has operation members such as switches and buttons and provides a user interface for the digital camera 100. A display unit 109 is constituted by an LCD (liquid crystal display) or the like and displays a reduced image of the image photographed. The display unit 109 displays settings, states, warnings, and the like concerning the digital camera 100 as marks, icons, and messages.

A program memory 110 is a nonvolatile memory having stored therein a control program and the like for controlling operations of the digital camera 100. A memory card 111 is an example of a removable storage medium. It is possible to use an SD memory card, a compact flash (registered trademark), or the like as the memory card. The storage medium used for the digital camera 100 is not limited to the memory card. It is also possible to use a removable hard disk or the like.

A communication control unit 102 includes a USB Device unit 1021 and a wireless communication unit 1022. The USB Device unit 1021 conforms to the USB standard such as USB 2.0 and controls data communication that uses the USB. The USB Device unit 1021 has a USB device controller module that causes the digital camera 100 to operate as a USB device. The wireless communication unit 1022 conforms to at least IEEE 802.11b and controls data communication that uses a wireless LAN. In this embodiment, the USB Device unit 1021 and the wireless communication unit 1022 are constituted to operate exclusively. However, the USB Device unit 1021 and the wireless communication unit 1022 may be constituted to operate in parallel. In this embodiment, the data communication that uses the USB is wired communication and the data communication that uses a wireless LAN is wireless communication.

The digital camera 100 may use a part of the second storage unit 107 like the memory card 111. In this case, even when the memory card 111 is not inserted in the digital camera 100, the digital camera 100 can photograph a still image or a moving image using the second storage unit 107 as a storage medium.

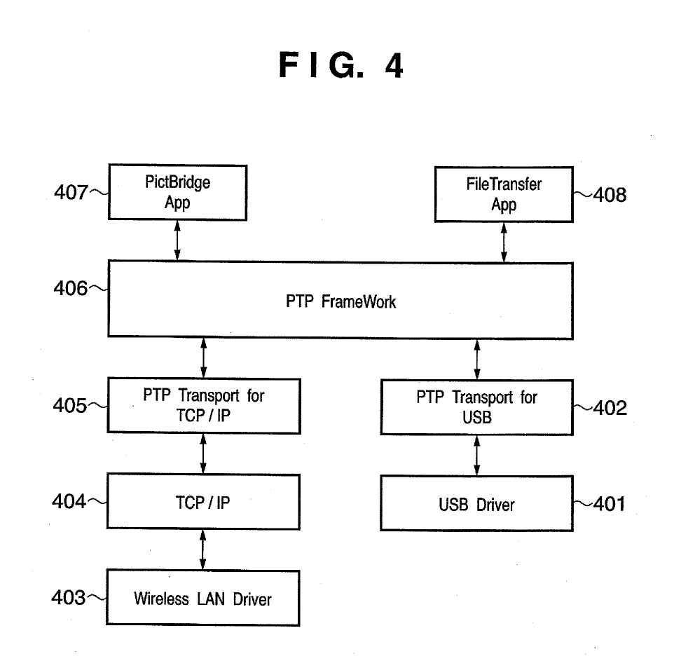

FIG. 4 is a diagram for explaining software modules implemented in the digital camera 100 according to this embodiment, a relation among the software modules, and operations of the software modules. The respective software modules shown in FIG. 4 are stored in a program storing area in the program memory 110. One or more of the modules shown in FIG. 4 may be realized by hardware.

A USB Driver 401 is a module used in controlling the USB Device unit 1021 to perform USB connection with an external device such as the PC 200. The USB Driver 401 is a module that functions as a USB imaging class (image class) driver. A PTP Transport for USB 402 is a module that provides a portion equivalent to a transport layer of the PTP (Picture Transfer Protocol) used in an imaging class. The PTP Transport for USB 402 understands specifications of the PTP and USB-specific specifications and performs necessary transport. With the USB Driver 401 and the PTP Transport for USB 402, when the digital camera 100 is connected to the external device by the USB, constitution of the USB is completed if an imaging device is usable in an environment on a host side.

A PTP FrameWork 406 is a module that processes various PTP operations sent from a USB host and provides a framework for transmitting a PTP event from a device to a host.

Since a difference in a transport layer is already concealed, the PTP FrameWork 406 is never aware of a difference between the USB and the wireless LAN.

A PictBridge App 407 is an application module for realizing an operation conforming to PictBridge that is a standard for directly connecting a digital camera and a printer using the USB to cause the digital camera and the printer to operate. A File Transfer App 408 is an application module that operates, when file transfer is requested from an external device, in response to the request.

These application modules operate using the interface of the PTP FrameWork 406.

A Wireless LAN Driver 403 is a module that functions as a driver for the wireless LAN. The Wireless LAN Driver 403 is used for controlling the wireless communication unit 1022 in FIG. 2. A TCP/IP 404 is a module for realizing the TCP/IP protocol generally used in a network. The TCP/IP 404 exchanges packets between the digital camera 100 and the external device via the Wireless LAN Driver 403.

A PTP Transport for TCP/IP 405 is, like the USB, a module that provides a portion equivalent to the transport layer of the PTP used in the imaging class. The PTP Transport for TCP/IP 405 understands specifications of the PTP and TCP/IP-specific specifications and performs necessary transport. Specifically, the PTP Transport for TCP/IP 405 includes packeting for transmitting PTP data corresponding to a host protocol on a TCP, unpacketing for restoring a packet from the TCP to PTP data, and the like.

With the intervention of the PTP Transport for TCP/IP 405 and the PTP Transport for USB 402, viewed from the PTP FrameWork 406, it is possible to handle the USB and the wireless LAN equivalently. The PictBridge App 407 and the File Transfer App 408, which operate on the PTP FrameWork 406, are also capable of operating without being aware via which of the USB and the wireless LAN the external device is connected.

As described above, the digital camera 100 according to this embodiment is capable of providing, in wireless communication, a function equivalent to a function at the time of wired connection in the USB if a connection counterpart is constituted to be capable of understanding the PTP transport applicable to wireless communication.

(Structure of the Wireless Communication Adapter 300)

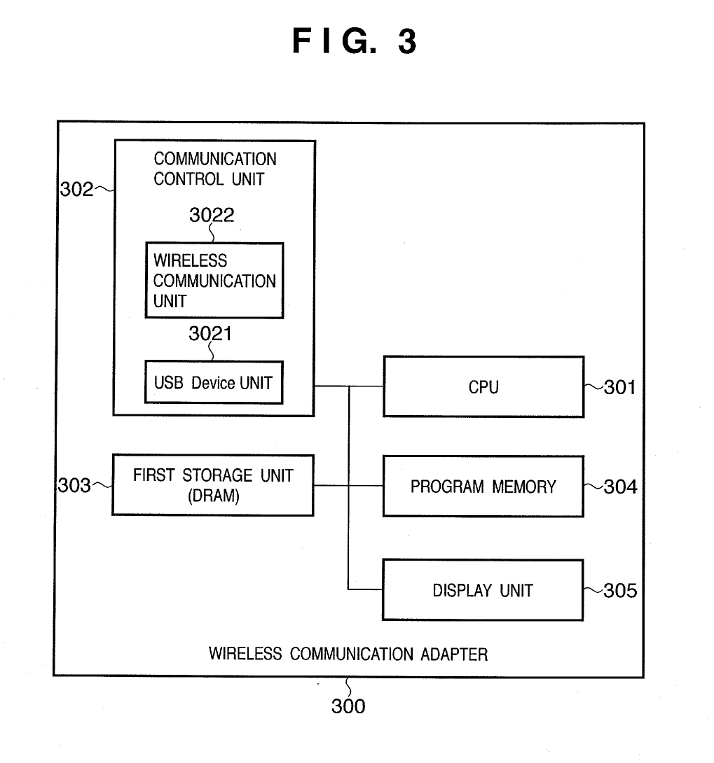

FIG. 3 is a block diagram showing an exemplary structure of the wireless communication adapter 300 according to this embodiment.

The wireless communication adapter 300 includes, a CPU (Central Processing Unit) 301, a first storage unit 303 constituted by a DRAM or the like, and a display unit 305 constituted by an LED or the like. The wireless communication adapter 300 further includes a program memory 304 having stored therein a control program and the like for controlling operations of the wireless communication adapter 300 and a communication control unit 302 that controls data communication with the outside.

The communication control unit 302 includes a USB Device unit 3021 and a wireless communication unit 3022. The USB Device unit 3021 conforms to the USB standard such as USB 2.0 and controls data communication that uses the USB. The wireless communication unit 3022 conforms to at least IEEE 802.11b and controls data communication that uses a wireless LAN. The USB Device unit 3021 is used for communication with the PC 200. The wireless communication unit 3022 is used for communication with the digital camera 100. In this embodiment, the USB device unit 3021 and the wireless communication unit 3022 are constituted to be capable of operating in parallel. This allows the wireless communication adapter 300 to communicate with the PC 200 using the USB while communicating with the digital camera 100 using the wireless LAN.

The USB Device unit 3021 has, like the USB Device unit 1021, a USB device controller module that causes the wireless communication adapter 300 to operate as a USB device.

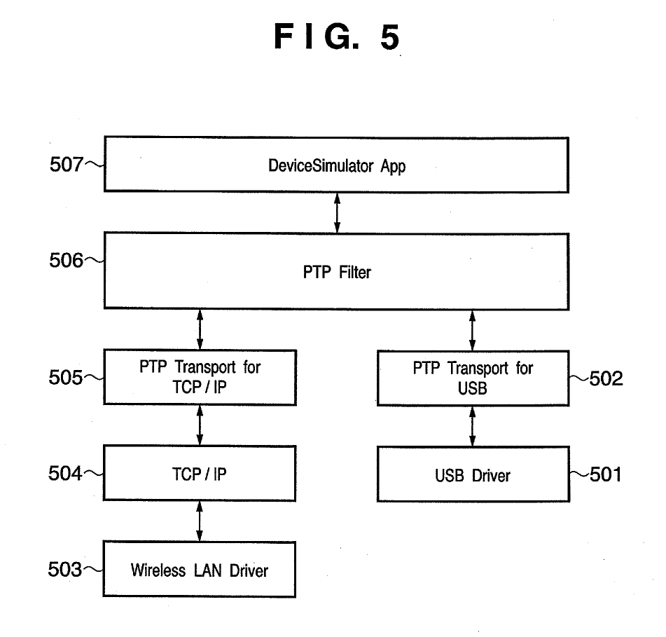

FIG. 5 is a diagram for explaining software modules implemented in the wireless communication adapter 300 according to this embodiment, a relation among the software modules, and operations of the software modules. The respective software modules shown in FIG. 5 are stored in a program storing area in the program memory 304. One or more of the modules shown in FIG. 5 may be realized by hardware.

A USB Driver 501 is a module used in controlling the USB Device unit 3021 to perform USB connection with the external device such as the PC 200. The USB Driver 501 is a module that functions as a USB imaging class (image class) driver. A PTP Transport for USB 502 is a module that provides a portion equivalent to a transport layer of the PTP (Picture Transfer Protocol) used in the imaging class. The PTP Transport for USB 502 understands specifications of the PTP and USB-specific specifications and performs necessary transport. With the USB Driver 501 and the PTP Transport for USB 502, when the digital camera 100 is connected to the external device by the USB, constitution of the USB is completed if an imaging device is usable in an environment on a host side.

A Wireless LAN Driver 503 is a module that functions as a driver for the wireless LAN. The Wireless LAN Driver 503 is used for controlling the wireless communication unit 3022 in FIG. 3. A TCP/IP 504 is a module for realizing the TCP/IP protocol generally used in a network. The TCP/IP 504 exchanges packets between the digital camera 100 and the external device via the Wireless LAN Driver 503.

A PTP Transport for TCP/IP 505 is, like the USB, a module that provides a portion equivalent to the transport layer of the PTP used in the imaging class. The PTP Transport for TCP/IP 505 understands specifications of the PTP and TCP/IP-specific specifications and performs necessary transport. Specifically, the PTP Transport for TCP/IP 505 includes packeting for transmitting PTP data corresponding to a host protocol on a TCP, unpacketing for restoring a packet from the TCP to PTP data, and the like.

With the modules 503 to 505, the wireless communication adapter 300 is capable of establishing wireless communication with the digital camera 100.

A PTP Filter 506 is a module that passes, in accordance with control by a Device Simulator App 507, various PTP operations sent from a USB host to the Device simulator App 507 or the PTP Transport for TCP/IP 505.

The PTP Filter 506 has a function of realizing, in a state in which the PC 200 serving as the external device is connected to the USB Device unit 3021 and wireless connection with the digital camera 100 is established, communication between the PC 200 and the digital camera 100. Specifically, the PTP Filter 506 has a function of transmitting communication data from the PC 200 to the digital camera 100 to the digital camera 100 through the wireless communication unit 3022. The PTP filter 506 also has a function of transmitting communication data from the digital camera 100 to the PC 200 to the PC 200 using the USB Device unit 3021.

A Device Simulator App 507 is an application module for simulating operations of the digital camera 100 such that, for the USB host, the wireless communication adapter 300 looks like a digital camera. Specifically, for communication from the PC 200 to the digital camera 100 in a state in which the PC 200 serving as the external device is connected to the USB Device unit 3021 and wireless connection with the digital camera 100 is not established, the Device Simulator App 507 responds by proxy for the digital camera 100.

The Device Simulator App 507 also has a function for holding camera connection state information representing a state of whether a digital camera is connected via the wireless communication unit 3022. The Device Simulator App 507 shifts the state of the camera connection state information on the basis of connection information informed via the PTP filter 506. The Device Simulator App 507 changes a delivery destination of an operation by the PTP filter 506 depending on whether a camera is wirelessly connected.

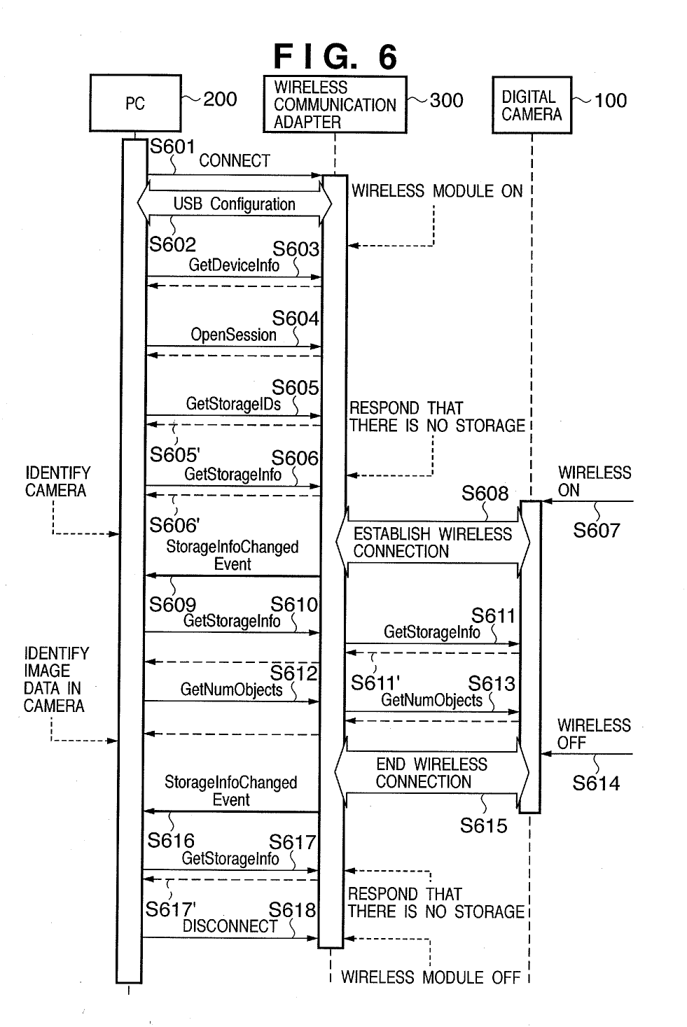

FIG. 6 is a sequence chart showing operations of the wireless communication adapter 300 according to the first exemplary embodiment together with operations of the digital camera 100 and the PC 200. Simulation operations of the wireless communication adapter 300 including connection and disconnection will be explained on the basis of the sequence chart.

First, the wireless communication adapter 300 is connected to the USB interface of the PC 200 (S601). According to operations of the USB Driver 501 serving as an imaging class driver and the PTP Transport for USB 502, the wireless communication adapter 300 is configured on a USB bus for the PC 200 (S602). After this configuration operation is completed, the wireless communication adapter 300 powers the wireless communication unit 3022 of the wireless communication adapter 300 and initializes the modules for wireless communication such as the Wireless LAN Driver 503 and the TCP/IP 504 to make the modules operable.

An OS that supports the PTP by standard is running on the PC 200. When a digital camera (an imaging class device) is connected to the PC 200, the PC 200 executes a PTP operation necessary for handling the digital camera in the PC 200.

Therefore, the PC 200 issues a PTP operation (command) group, which is the same as that issued when the digital camera is connected, to the wireless communication adapter 300 constituted on the USB bus as a device of the same imaging class as the digital camera. For example, PTP operations are a GetDeviceInfo operation (S603) for requesting information on the wireless communication adapter 300 serving as a responder in the PTP and an OpenSession operation (S604) for session start issued after the GetDeviceInfo operation. Moreover, a GetStorageIDs operation (S605) for requesting a StorageID available in the responder, a GetStorageInfo operation (S606) for requesting a state of a medium specified by the StorageID, and the like are issued following the OpenSession operation.

These operations are filtered by the PTP Filter 506 and all the operations are passed to the Device Simulator App 507. At this point, since the wireless communication adapter 300 is not wirelessly connected to the digital camera 100, a state of the digital camera 100 is held as unconnected in wireless camera state holding means in the Device Simulator App 507. In the case of this state, this Device Simulator App 507 responds to the respective operations at S603, S604, S605, and S606 on behalf of the actual digital camera 100.

Content of the response of the Device Simulator App 507 may be content that the PC 200 serving as an operation issue source is capable of processing as a response from a normal digital camera and content not inconsistent with a substance of the digital camera 100. However, as described above, since the actual digital camera 100 is not wirelessly connected at this point, it is necessary to prevent an operation, which requires a response exceeding a supported range, from being issued from the PC 200.

Therefore, the Device Simulator App 507 operates to respond to, in particular, the GetStorageIDs operation (S605) and the GetStorageInfo operation (S606) in the operation group, that the digital camera 100 is in a state in which a storage is not inserted therein.

Specifically, the Device Simulator App 507 responds with an appropriate number of StorageIDs (apportioned for each available logic store) to the GetStorageIDs operation (S605) (S605′). In response, the PC 200 issues the GetStorageInfo operation (S606) that designates any one of the StorageIDs. Thus, the Device Simulator App 507 may respond that a designated store cannot be used with Store Not available or the like (S606′).

By performing such response, the PC 200 recognizes that, although the digital camera 100 is normally connected by the USB at this point, image information or the like is not present in the digital camera 100. Therefore, the PC 200 does not issue an operation for requesting information required by the actual digital camera 100. No problem occurs even if the digital camera 100 is not wirelessly connected.

In this state, when the digital camera 100 is brought into a state in which wireless communication is possible by user operation (S607), the wireless communication adapter 300 and the digital camera 100 are logically connected in a hierarchy of the PTP (S608). It is possible to realize this connection because the PTP Transport for TCP/IP 405 and the modules below the PTP Transport for TCP/IP 405 in the digital camera 100 and the PTP Transport for TCP/IP 505 and the modules below the PTP Transport for TCP/IP 505 in the wireless communication adapter 300 are designed such that the modules can be linked each other.

Specifically, the Wireless LAN Driver 403 and the Wireless LAN Driver 503 are connected according to a protocol conforming to IEEE 802.11b. The TCP/IP 404 and the TCP/IP 504 are linked according to a general-purpose TCP/IP protocol. Between the PTP Transport for TCP/IP 405 and the PTP Transport for TCP/IP 505, a TCP/IP transport protocol of the PTP proposed by Fotonation Inc. is used.

When the wireless communication adapter 300 and the digital camera 100 are wirelessly connected in this way, the Device Simulator App 507 shifts the state held in the wireless camera state information of the Device Simulator App 507 to “wireless connection is in progress”. The Device Simulator App 507 issues a StorageInfoChanged event for informing that information on the storage in the digital camera 100 is changed to the PC 200 (S609). This is a standard event of the PTP and is an event treated even at the time of usual wired USB connection. Therefore, the PC 200, which has received this event, usually issues a GetStorageInfo operation (S610), a GetNumObjects operation (S612) for requesting the number of objects in the storage, or the like in order to acquire the content change.

When the wireless camera state information held by the Device Simulator App 507 indicates “wireless connection is in progress”, the Device Simulator App 507 instructs the PTP Filter 506 to pass the PTP operation issued from the PC 200 to the digital camera 100 wirelessly connected. Therefore, the GetStorageInfo operation (S610) issued from the PC 200 in response to the StorageInfoChanged event is passed to the PTP Transport for TCP/IP 505. The GetStorageInfo operation (S610) is converted into a form based on the PTPIP and sent to the digital camera 100 via the TCP/IP 504 and the Wireless LAN Driver 503 (S611).

As described above, when both the wired connection with the PC 200 and the wireless connection of the digital camera 100 are established, the modules 501 to 506 provide a protocol conversion function for converting wired communication and wireless communication.

The digital camera 100 returns actual storage information in the camera 100 to the wireless communication adapter 300 in response to this operation (S611′). When the PTP Filter 506 of the wireless communication adapter 300 receives this response through the modules 503 to 505, the PTP Filter 506 passes response data to the USB Transport for USB 501. The PTP Filter 506 transmits the response data to the PC 200 via the USB through the modules 502 and 501.

Consequently, the PC 200 can establish a state that actually reflects information on the storage in the digital camera 100. The same holds true for the GetNumObjects operation (S612). The operation is sent to the digital camera 100 (S613) and a response from the digital camera 100 is transmitted to the PC 200 by the wireless communication adapter 300.

Consequently, viewed from the PC 200, completely the same state as the state in which the digital camera 100 is connected by USB connection is established. Thus, it is possible to directly use the application that conventionally operates on condition that the USB connection is performed.

Thereafter, when the wireless communication of the digital camera 100 is turned off by user operation (S614), a wireless disconnection event is issued from the digital camera 100 to the wireless communication adapter 300. In response to this wireless disconnection event, wireless disconnection processing (S615) is executed by the wireless communication adapter 300. In this processing, the Device Simulator App 507 returns the state held in the wireless camera state information to an un-connection state. The Device Simulator App 507 instructs the PTP Filter 506 to transmit an operation issued from the PC 200 to the Device Simulator App 507 rather than the PTP Transport for TCP/IP 505.

The Device Simulator App 507 issues the StorageInfoChanged event to the PC 200 again (S616). This is the standard event of the PTP as described above and is an event treated in the conventional USB connection as well. Therefore, the PC 200, which has received this event, issues the GetStorageInfo operation to the wireless communication adapter 300 again in order to reflect the content change (S617). However, since the digital camera 100 is already in the wireless un-connection state, as in the first stage described above, this operation is passed to the Device Simulator App 507. The Device Simulator App 507 performs proxy response indicating that there is no storage of the digital camera 100 (S617′).

If the user removes the wireless communication adapter 300 from the PC 200 (S618), the wireless communication adapter 300 stops power supply to the wireless communication unit 3022 in response to the removal and stops the wireless related modules.

As described above, the wireless communication adapter 300 according to this embodiment behaves as the digital camera 100 for the external device having the wired communication function while the wireless connection with the digital camera 100 is not established. After the wireless connection with the digital camera 100 is established, the wireless communication adapter 300 brides communication between the external device and the digital camera 100. Therefore, it is possible to directly use the software, which is provided on condition that the wired connection of the digital camera 100 is used, running on the external device to handle the digital camera 100 wirelessly connected.

Therefore, even in the PC 200 that does not have the wireless communication function, if the wireless communication adapter 300 according to this embodiment is connected to the PC 200, it is possible to use the digital camera 100 having the wireless communication function without installing new software.

Moreover, even in the PC 200 that has already established a wireless network, it is possible to perform the wireless communication of the digital camera 100 and the PC 200 using the wireless communication adapter 300. Therefore, it is unnecessary to adjust a difficult wireless network setting or the like to a setting of the existing wireless network. Thus, it is possible to establish a simple and flexible wireless communication environment.

In this embodiment, the PTP event for informing that information on the storage has changed is issued to the wireless communication adapter 300 and the PC 200 at the time of establishment and at the time of disconnection of the wireless connection with the digital camera 100. However, a PTP event (a DeviceInfoChanged event) for informing that information on the device (the camera) itself has changed may be issued instead of the PTP event.

<Second Exemplary Embodiment>

A second exemplary embodiment, which is a modification of the first exemplary embodiment, will be explained. Since the second exemplary embodiment is the modification of the first exemplary embodiment, components identical with those in the first exemplary embodiment are denoted by the identical reference numerals and signs and explanations of the components are omitted.

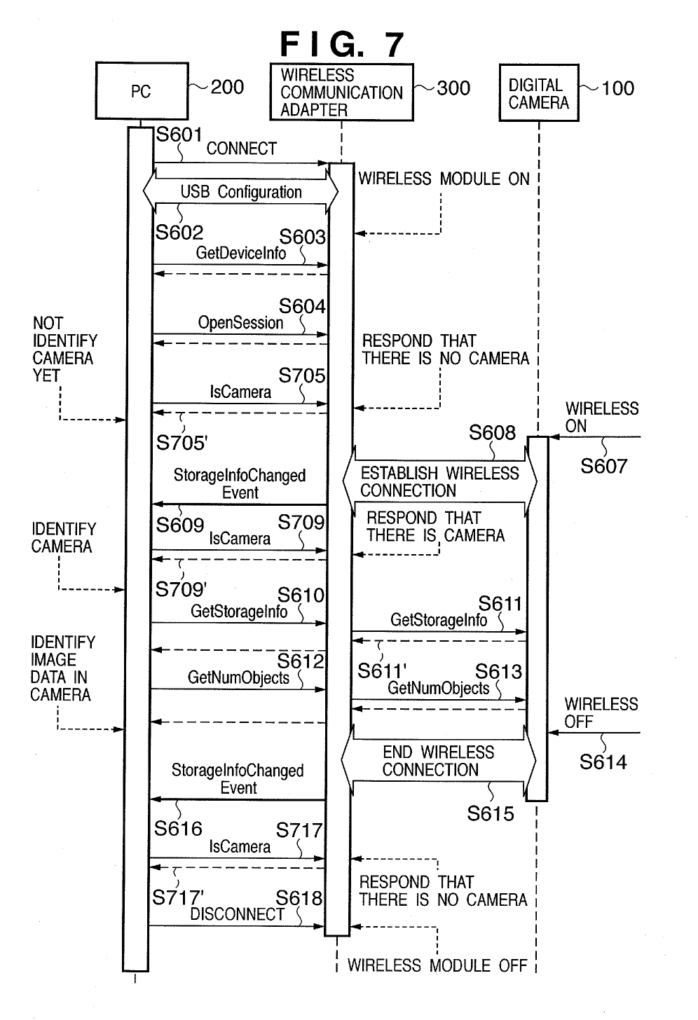

FIG. 7 is a sequence chart for explaining operations of the wireless communication adapter 300 according to the second exemplary embodiment. In FIG. 7, steps identical with those in FIG. 6 are denoted by the identical reference signs.

Structures of the digital camera 100, the PC 200, and the wireless communication adapter 300 may be the same as those in the first exemplary embodiment. Operations issued by the PC 200 and a method of response to the operations by the Device Simulator App 507 are different from those in the first exemplary embodiment.

Steps (S601 to S604) from connection of the wireless communication adapter 300 to the PC 200 until a session is established are the same as those in the first exemplary embodiment.

However, this embodiment is different from the first exemplary embodiment in that an operation issued by the PC 200 after the session is established is an IsCamera operation rather than the GetStorageIDs operation (S705). This operation is an operation for checking whether the wireless communication adapter 300 is in a state of connection with the digital camera 100. At this point, since wireless connection of the wireless communication adapter 300 and the digital camera 100 has not been established yet, the IsCamera operation is passed to the Device Simulator App 507.

The Device Simulator App 507 responds that the digital camera 100 has not been connected yet (S705′). Consequently, since the PC 200 can judge that the digital camera 100 has not been logically connected yet, the PC 200 can perform processing correctly considering that the digital camera 100 is not present at this point.

For example, in the case in which the PC 200 is set to perform a specific operation at a point when the digital camera 100 is identified, in the first exemplary embodiment, this specific operation is executed even if the digital camera 100 is not actually present when the wireless communication adapter 300 is connected. For example, a message such as “a medium is not inserted” is displayed. Therefore, it is likely that some users may be afraid that the users have performed wrong operation.

On the other hand, in this embodiment, since the PC 200 can recognize that the digital camera 100 has not been actually connected yet, it is possible to prevent such a problem.

In this state, when the digital camera 100 is brought into a state in which wireless communication is possible by user operation (S607), the wireless communication adapter 300 and the digital camera 100 are logically connected in a hierarchy of the PTP (S608).

When the wireless communication adapter 300 and the digital camera 100 are wirelessly connected in this way, the Device Simulator App 507 issues a StorageInfoChanged event for informing that information on the storage in the digital camera 100 has changed to the PC 200 (S609). In this embodiment, a state of wireless camera state information held by the Device simulator App 507 is not shifted to “wireless connection is in progress” at this point.

In response to the StorageInfoChanged event, the PC 200 issues an IsCamera operation and checks whether wireless connection of the digital camera 100 and the wireless communication adapter 300 is established (S709). In response to the IsCamera operation, the Device Simulator App 507 responds that the wireless connection is established and the digital camera 100 is connected (S709′).

In this embodiment, when the Device Simulator App 507 receives the IsCamera operation, the Device Simulator App 507 shifts the state held in the wireless camera state information thereof to “wireless connection is in progress”. After that, the Device Simulator App 507 instructs the PTP Filter 506 to pass a PTP operation issued from the PC 200 to the digital camera 100 wirelessly connected.

The PTP Filter 506 may be constituted to pass the IsCamera operation to the Device Simulator App 507 regardless of an instruction from the Device Simulator App 507. In this case, timing at which the Device Simulator app 507 shifts the state held in the wireless camera state information of the Device Simulator App 507 to “wireless connection is in progress” may be the same as that in the first exemplary embodiment.

When the PC 200 confirms the presence of the digital camera 100, the PC 200 issues operations for obtaining a method necessary for reading out image data from the digital camera 100. As explained in the first exemplary embodiment, usually, the operations are the GetStoragelnfo operation (S610), the GetNumObjects operation (S612), and the like.

The PTP Filter 506 passes these operations to the PTP Transport for TCP/IP 505. These operations are converted into a form based on the PTPIP and sent to the digital camera 100 via the TCP/IP 504 and the Wireless LAN Driver 503 (S611 and S613).

In response to the GetStorageInfo operation, the digital camera 100 returns actual storage information in the camera 100 to the wireless communication adapter 300 (S611′). When the PTP Filter 506 of the wireless communication adapter 300 receives this response through the modules 503 to 505, the PTP Filter 506 passes response data to the USB Transport for USB 501. The PTP Filter 506 transmits the response data to the PC 200 via the USB through the modules 502 and 501.

Consequently, the PC 200 can establish a state that actually reflects information on the storage in the digital camera 100. The same holds true for the GetNumObjects operation (S612). The operation is sent to the digital camera 100 (S613) and a response from the digital camera 100 is transmitted to the PC 200 by the wireless communication adapter 300.

Consequently, viewed from the PC 200, completely the same state as the state in which the digital camera 100 is connected by USB connection is established. Thus, it is possible to directly use the application that conventionally operates on condition that the USB connection is performed.

Thereafter, when the wireless communication of the digital camera 100 is turned off by user operation (S614), a wireless disconnection event is issued from the digital camera 100 to the wireless communication adapter 300. In response to this wireless disconnection event, wireless disconnection processing (S615) is executed by the wireless communication adapter 300. In this processing, the Device Simulator App 507 returns the state held in the wireless camera state information to an un-connection state. The Device Simulator App 507 instructs the PTP Filter 506 to transmit an operation issued from the PC 200 to the Device Simulator App 507 rather than the PTP Transport for TCP/IP 505.

The Device Simulator App 507 issues the StorageInfoChanged event to the PC 200 again (S616). In response to the StorageInfoChanged event, the PC 200 issues an IsCamera operation and checks whether the digital camera 100 has established wireless connection with the wireless communication adapter 300 (S717). This operation is passed to the Device Simulator App 507. The Device Simulator App 507 responds that no camera is present (S717′).

If the user removes the wireless communication adapter 300 from the PC 200 (S618), the wireless communication adapter 300 stops power supply to the wireless communication unit 3022 in response to the removal and stops the wireless related modules.

As explained above, according to this embodiment, in addition to the advantages of the first exemplary embodiment, it is possible to provide the PC 200 with an operation closer to the state of the wired connection than the operation in the first exemplary embodiment.

In this embodiment, as in the first exemplary embodiment, the PTP event for informing that information on the storage has changed is issued to the wireless communication adapter 300 and the PC 200 at the time of establishment and at the time of disconnection of the wireless connection with the digital camera 100. However, a PTP event (a DeviceInfoChanged event) for informing that information on the device (the camera) itself has changed may be issued instead of the PTP event.

In this embodiment, at the time of connection and at the time of disconnection of the digital camera 100, the Device Simulator App 507 informs the PC 200 of presence or absence (presence or absence of connection) of the digital camera 100 according to the steps of 1) issuing the DeviceInfoChanged event, 2) standing by for issuance of an operation for checking presence or absence of the digital camera 100, and 3) responding to the operation issued with a connection state.

However, the same advantages are obtained when the Device Simulator App 507 refers to the wireless camera state information held by the Device Simulator App 507 itself and directly transmits a wireless digital camera connection event and a wireless digital camera disconnection event to the PC 200 instead of the DeviceInfoChanged event.

While the present invention has been described with reference to exemplary embodiments, it is to be understood that the present invention is not limited to the disclosed exemplary embodiments. The scope of the following claims is to be accorded the broadest interpretation so as to encompass all modifications, equivalent structures and functions.

This application claims the benefit of Japanese Patent Application No. 2005-267692, filed on Sep. 14, 2005, which is hereby incorporated by reference herein its entirety.

1.-6. (canceled)

7. A communication device comprising:
a first communication unit configured to communicate with a first device having a first controller, the first communication unit receiving from the first device a command issued to a second device, wherein the first communication unit is detachable from the first device;
a second communication unit configured to communicate with the second device;
a detection unit configured to detect a connection state between the second communication unit and the second device in a case where a connection is established between the first communication unit and the first device; and
a second controller being different from the first controller of the first device and configured to, in accordance with a detection result of the connection state between the second communication unit and the second device by the detection unit, control a communication operation of the first communication unit to send a response to a command, which is issued to the second device and is received from the first device such that:
if the detection result indicates that a connection is not established between the second communication unit and the second device, the second controller controls the first communication unit so as to generate a first response to the command, which is issued to the second device and is received from the first device, so that the first device does not recognize that a connection is not established between the first device and the second device, and controls the first communication unit to send to the first device the generated first response as a response from the second device.

8. The communication device according to claim 7, wherein the first communication unit communicates with the first device using a first communication method, and the second communication unit communicates with the second device using a second communication method different from the first communication method.

9. The communication device according to claim 7, wherein a recording medium is loadable in the second device, and
wherein if the detection result indicates that a connection is not established between the second communication unit and the second device, the second controller further controls the first communication unit so as to send information indicating that no recording medium is loaded in the second device as a response generated by the second device in response to a command, which is received from the first device and which requests information relating to the recording medium loaded in the second device.

10. The communication device according to claim 7, wherein if the detection result indicates that a connection is established between the second communication unit and the second device, the second controller further controls the second communication unit so as to send the command to the second device and to receive a second response, which is generated by the second device in response to the command, and the second controller further controls the first communication unit so as to send the received second response to the first device.

11. A communication device comprising:
a first communication unit configured to communicate with a first device having a first controller, the first communication unit receiving from the first device a command issued to a second device, wherein the first communication unit being detachable from the first device;
a second communication unit configured to communicate with the second device;
a detection unit configured to detect a connection state between the second communication unit and the second device in a case where a connection is established between the first communication unit and the first device; and
a second controller being different from the first controller of the first device and configured to, in accordance with a detection result of the connection state between the second communication unit and the second device by the detection unit, control a communication operation of the first communication unit to send a response to a command, which is issued to the second device and is received from the first device and a communication operation of the second communication unit such that:
if the detection result indicates that a connection is not established between the second communication unit and the second device, the second controller controls the first communication unit so as to generate a first response to the command, which is issued to the second device and is received from the first device, so that the first device does not recognize that a connection is not established between the first device and the second device, and to send the generated first response to the first device as a response from the second device, and
if the detection result indicates that a connection is established between the second communication unit and the second device, the second controller controls the second communication unit so as to send the command, which is issued to the second device and is received from the first device, to the second device, and controls the first communication unit so as to send a second response, which is actually generated by and received from the second device in response to the command sent to the second device, to the first device.

12. The communication device according to claim 11, wherein a recording medium is loadable in the second device and
wherein the second controller further controls the first communication unit so as to inform the first device that a state of a recording medium loaded in the second device is changed, responsive to a change of a connection state between the second communication unit and the second device from a state where a connection is not established to a state where a connection is established.

13. The communication device according to claim 11, wherein the first device is a computer and the second device is a camera which captures an image data and records the image data in a recording medium loaded in the camera.

14. The communication device according to claim 11, wherein a recording medium is loadable in the second device, and
wherein if the detection result indicates that a connection is not established between the second communication unit and the second device, the second controller further controls the first communication unit so as to send information indicating that no recording medium is loaded in the second device as a response generated by the second device in response to a command, which is received from the first device and which requests information relating to the recording medium loaded in the second device.

15. The communication device according to claim 11, wherein the first communication unit communicates with the first device by a wired communication and the second communication unit communicates with the second device by a wireless communication.

16. The communication device according to claim 11, wherein if the detected result indicates that a connection is established between the second communication unit and the second device, the second controller further controls the second communication unit so as to send the command to the second device and to receive a second response, which is generated by the second device in response to the command, and the second controller further controls the first communication unit so as to send the received second response to the first device as a response to the command.

17. A communication device comprising:
a first communication unit configured to communicate with a first device, having a first controller, the first communication unit receiving from the first device a command issued to a second device, the first communication unit being detachable from the first device;
a second communication unit configured to communicate with the second device;
a detection unit configured to detect a connection state between the second communication unit and the second device in a case where a connection is established between the first communication unit and the first device; and
a second controller being different from the first controller of the first device and configured to, in accordance with a detection result of the connection state between the second communication unit and the second device, control a communication operation of the first communication unit to send a response to a command, which is issued to the second device and is received from the first device and a communication operation of the second communication unit by setting a mode of the communication device from among a plurality of modes including a first mode and a second mode such that:
if the detection result indicates that a connection is not established between the second communication unit and the second device, the second controller sets the first mode in which the first communication unit generates a first response to the command, which is issued to the second device and is received from the first device, so that the first device does not recognize that a connection is not established between the first device and the second device, and sends to the first device the generated first response as a response from the second device, and
if the detection result indicates that a connection is established between the second communication unit and the second device, the second controller sets the second mode, in which the second communication unit sends the command, which is issued to the second device and is received from the first device, to the second device,.

18. The communication device according to claim 17, wherein in the second mode, the first communication unit further sends a response received from the second device in response to the command back to the first device.

19. The communication device according to claim 17, wherein the first communication unit communicates with the first device using a first communication method, and the second communication unit communicates with the second device using a second communication method different from the first communication method.

20. The communication device according to claim 17, wherein in the second mode, the second communication unit sends the command to the second device and receives a second response, which is generated by the second device in response to the command, and the first communication unit sends the received second response to the first device as a response to the command.

21. A communication device comprising:
a wired communication unit configured to communicate with a first device comprising a first controller;
a wireless communication unit configured to communicate with a second device;
a detection unit configured to detect a connection state between the wireless communication unit and the second device in a case where a connection is established between the wired communication unit and the first device; and
a second controller being different from the first controller and configured to, in accordance with a detection result of the connection state between the wireless communication unit and the second device by the detection unit, control a communication operation of the wired communication unit to send a response to a command, which is issued to the second device and is received from the first device, and a communication operation of the wireless communication unit such that:
if the detected connection state indicates that a connection is not established between the wireless communication unit and the second device, the second controller controls the wired communication unit so as to generate a first response to the command, which is issued to the second device and is received from the first device, so that the first device does not recognize that a connection is not established between the first device and the second device, and to send to the first device the generated first response as a response from the second device, and
if the detected connection state indicates that a connection is established between the wireless communication unit and the second device, the second controller controls the wireless communication unit so as to send the command, which is issued to the second device and is received from the first device, to the second device, and controls the wired communication unit so as to send a second response, which is actually generated by and received from the second device in response to the command sent to the second device, to the first device.

22. The communication device according to claim 21, wherein the second device is configured to use a recording medium, and
wherein if the detection result indicates that a connection is not established between the wireless communication unit and the second device, the second controller controls the wired communication unit, in response to a command about the recording medium received from the first device, so as to send to the first device a response indicating that the second device cannot use the recording medium.

23. The communication device according to claim 21, wherein the communication device is connected to the first device as an adapter that enables the first device to perform wireless communication.
